(19) United States
(12) Patent Application Publication
(10) Pub. No.: US 2024/0345392 A1
(43) Pub. Date: Oct. 17, 2024

(54) VEHICLE DISPLAY DEVICE

(71) Applicant: YAZAKI CORPORATION, Tokyo (JP)

(72) Inventors: Kunimitsu Aoki, Susono-shi (JP); Nobuyuki Takahashi, Susono-shi (JP); Go Nakamura, Susono-shi (JP)

(21) Appl. No.: 18/755,569

(22) Filed: Jun. 26, 2024

Related U.S. Application Data
(63) Continuation of application No. PCT/JP2023/007970, filed on Mar. 3, 2023.

(30) Foreign Application Priority Data
Mar. 7, 2022 (JP) 2022-034523

(51) Int. Cl. G02B 27/01; B60K 35/235; B60K 35/81

(52) U.S. Cl. CPC G02B 27/0101; G02B 27/0179; B60K 35/235; B60K 35/81; B60K 2360/23; G02B 2027/0187

(57) ABSTRACT

A vehicle display device includes a display unit that emits display information to be visually recognized by a driver as display light, and an aspheric mirror that reflects the display light toward a windshield. The display unit emits the display light that is narrower than an eye range based on a distribution range of eye points of a plurality of drivers, and corresponds to an eye box, which is a light distribution range based on an acquired eye point.

### CROSS-REFERENCE TO RELATED APPLICATION(S)

This application is a continuation application of International Application No. PCT/JP2023/007970 filed on Mar. 3, 2023 which claims the benefit of priority from Japanese Patent Application No. 2022-024523 filed on Mar. 7, 2022 and designating the U.S., the entire contents of which are incorporated herein by reference.

### BACKGROUND OF THE INVENTION

### 1. Field of the Invention

The present invention relates to a vehicle display device.

### 2. Description of the Related Art

A head-up display (HUD) mounted on a vehicle such as an automobile displays a virtual image on the front of the vehicle by reflecting display light emitted from a display unit by a reflection mirror and projecting the display light onto a windshield, and enables a driver to visually recognize the virtual image (for example, see Japanese Patent Application Laid-open No. 2016-14861 and Japanese Patent Application Laid-open No. 2021-84466).

In a conventional HUD, a decrease in visibility of a virtual image is suppressed by, for example, setting a light distribution range of display light emitted from a display unit to be relatively wide in accordance with an eye range indicating a distribution of a plurality of eye points defined in JIS or the like, and pivoting a reflection mirror about an axis in accordance with a change in posture of a driver in an up-down direction.

In a case where the light distribution range of the display light is set to be relatively wide in accordance with the eye range, a plurality of high-luminance LEDs are used as a light source, resulting in an increase in size of a heat sink serving as a countermeasure against heat from the light source. Therefore, there is room for improvement because, in a case where the light distribution range of the display light according to the eye range is set to be relatively narrow, like an eye box according to an eye point of one driver, it is not easy to cope with a driver who is out of the eye range, for example, only by widening a pivot range of a reflection mirror.

### SUMMARY OF THE INVENTION

The present invention has been made in view of the aforementioned problem, and an object of the present invention is to provide a vehicle display device capable of reducing power consumed by a display unit.

In order to achieve the above mentioned object, a vehicle display device according to one aspect of the present invention includes a display unit that emits display information as display light, the display information being projected onto a projected member of a vehicle and visually recognized by a driver inside the vehicle as a virtual image; a reflector that reflects the display light incident from the display unit toward the projected member; an eye point acquisition unit that acquires an eye point of the driver, a unit driver that drives the display unit to change a direction of the display light from the display unit toward the reflector; a reflector driver that drives the reflector to change a direction of the display light from the reflector toward the projected member; and a control unit that drives and controls the unit driver and the reflector driver on the basis of the acquired eye point, wherein the display unit emits the display light that is narrower than an eye range, which is a light distribution range based on a distribution range of eye points of a plurality of drivers, and corresponds to an eye box, which is a light distribution range based on the eye point of the driver acquired by the eye point acquisition unit, and the control unit changes an optical path of the display light from the display unit to the eye point on the basis of the acquired eye point by driving and controlling the unit driver and the reflector driver in conjunction with each other.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram illustrating a configuration example of a vehicle display device according to an embodiment;

FIG. 2 is a block diagram illustrating a functional configuration of the vehicle display device according to the embodiment;

FIG. 3 is a schematic diagram for explaining a relationship between a position of an eye point in an up-down direction and an optical path of display light acquired by the vehicle display device according to the embodiment;

FIG. 4 is a schematic diagram for explaining a relationship between a position of an eye point in a left-right direction and a position of a virtual image acquired by the vehicle display device according to the embodiment;

FIG. 5 is a schematic diagram illustrating a schematic configuration of a display unit and a reflection mirror unit as viewed in a left-right direction;

FIG. 6 is a schematic diagram illustrating a schematic configuration of the display unit and the reflection mirror unit as viewed in an up-down direction;

FIG. 7 is a schematic diagram illustrating a schematic configuration of the display unit as viewed from the front;

FIG. 8 is a schematic diagram illustrating a schematic configuration of the display unit as viewed from below;

FIG. 9 is a schematic diagram illustrating a schematic configuration of a display unit according to a first modification of the embodiment;

FIG. 10 is a schematic diagram illustrating a schematic configuration of a display unit according to a second modification of the embodiment;

FIG. 11 is a schematic diagram illustrating a schematic configuration of a display unit according to a third modification of the embodiment;

FIG. 12 is a schematic diagram of a schematic configuration of a display unit according to a fourth modification of the embodiment as viewed from the front; and

FIG. 13 is a schematic diagram of a schematic configuration of the display unit according to the fourth modification of the embodiment as viewed from below.

### DETAILED DESCRIPTION OF THE PREFERRED EMBODIMENTS

Hereinafter, an embodiment of a vehicle display device according to the present invention will be described in detail with reference to the drawings. Note that the present invention is not limited by the present embodiment. In addition, the constituent elements in the following embodiment include those that can be easily imagined by those skilled in the art or those that are substantially the same. In addition, various omissions, substitutions, and changes can be made to the constituent elements in the following embodiment without departing from the gist of the invention.

### EMBODIMENT

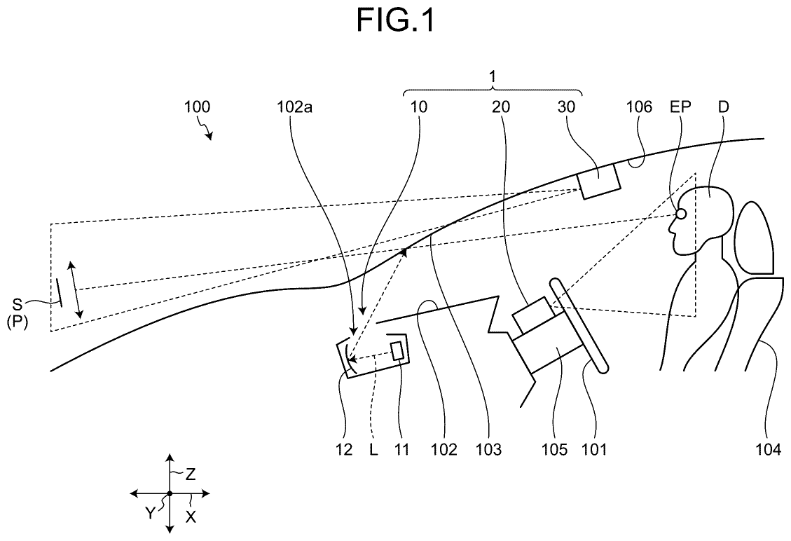

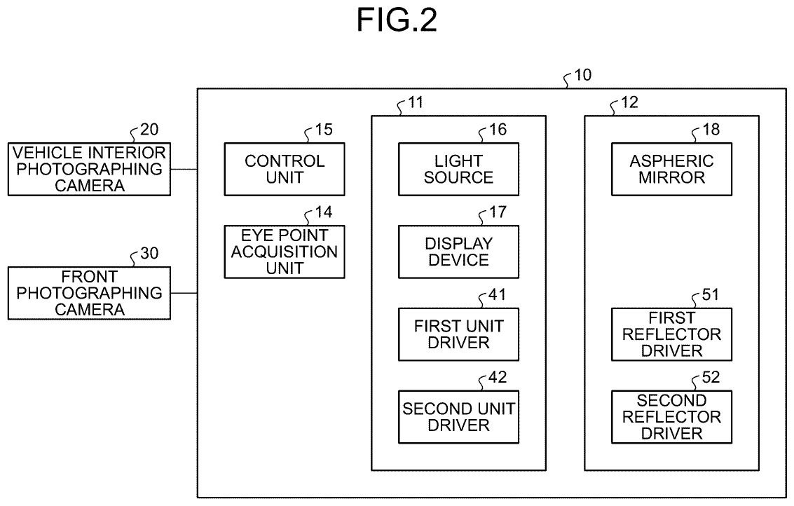

As illustrated in FIG. 1, a vehicle display device 1 is mounted on a vehicle 100 such as an automobile, for example, and displays various types of information including a speed of the vehicle 100 and the like to assist the driver D in driving. The vehicle display device 1 of the present embodiment includes a device main body 10, a vehicle interior photographing camera 20, and a front photographing camera 30. The vehicle display device 1 projects a display image on the basis of display information from the device main body 10 onto a windshield 103 of the vehicle 100, and causes a virtual image S corresponding to the display image projected onto the windshield 103 to be visually recognized from a viewpoint position (eye point EP) of the driver D in the vehicle 100. The windshield 103 has semipermeability, and reflects display light L incident from the device main body 10 toward the eye point EP of the driver D. The eye point EP is a viewpoint position of the driver D seated on a driver's seat 104. The driver D can visually recognize the display image projected onto the windshield 103 as the virtual image S existing in front of the vehicle 100 in the traveling direction.

In the following description, the X direction in the drawings is a front-rear direction of the vehicle 100. The Y direction is a left-right direction of the vehicle 100, and is a direction orthogonal to the front-rear direction. The Z direction is an up-down direction of the vehicle 100, and is a direction orthogonal to the front-rear direction and the left-right direction.

Here, it is assumed in advance that the eye point EP is located in an eye box EB set within a so-called eye range ER in the vehicle 100. The eye range ER is a distribution range of eye points of a plurality of drivers D in the vehicle 100, and corresponds to, for example, an area including a predetermined ratio (for example, 95%) of the eye points of the drivers D in a state where the drivers D are seated on the driver's seat 104. The eye box EB of the present embodiment is narrower than the eye range ER, and is a light distribution range based on the eye point EP of the driver D acquired by an eye point acquisition unit 14 to be described below, for example, an appropriate range in which the driver D can visually recognize the virtual image S while driving in a state where the driver D is seated on the driver's seat 104. The eye point EP is acquired, for example, by an eye point acquisition unit 14 to be described below on the basis of a driver image.

The vehicle interior photographing camera 20 is disposed inside the vehicle 100, and consecutively images of a face portion of the driver D. The vehicle interior photographing camera 20 is, for example, a monocular camera, and is disposed on an upper side of a steering column 105 inside the vehicle and behind a steering wheel 101 as viewed from the driver D. The vehicle interior photographing camera 20 is connected to the device main body 10 via a communication line or the like, and sequentially outputs the captured images to the device main body 10 as driver images. The driver image is, for example, a still image of the face portion of the driver D viewed from the front. The driver image may be a moving image.

The front photographing camera 30 is disposed inside the vehicle 100, and consecutively images actual scenery in front of the vehicle through the windshield 103. The front photographing camera 30 is, for example, a so-called stereo camera, and is disposed on a roof 106 or a rearview mirror (not illustrated) inside the vehicle. The front photographing camera 30 is connected to the device main body 10 via a communication line or the like, and sequentially outputs the captured images to the device main body 10 as front images. The front image is, for example, a still image obtained by imaging actual scenery in front of the vehicle. The front image may be a moving image. The vehicle display device 1 may not include the front photographing camera 30.

The device main body 10 is disposed inside an instrument panel 102, and projects a display image onto the windshield 103, which is a projected member. An opening 102a is provided on an upper surface of the instrument panel 102. The device main body 10 projects the display image by emitting display light L toward the windshield 103 through the opening 102a. The device main body 10 of the present embodiment includes a display unit 11, a reflection mirror unit 12, an eye point acquisition unit 14, and a control unit 15. The control unit 15 is connected to the display unit 11, the reflection mirror unit 12, and the eye point acquisition unit 14 via communication lines or the like in the device main body 10.

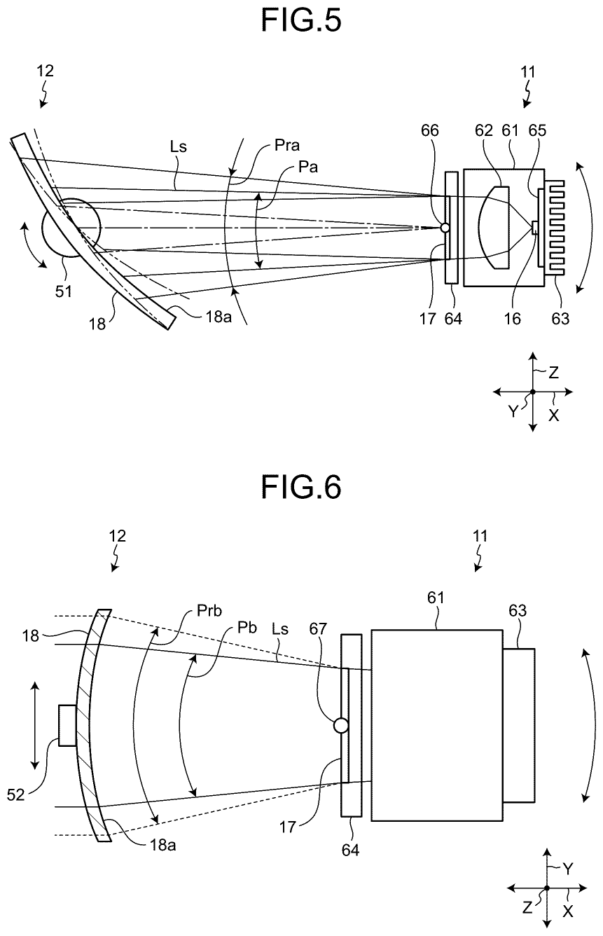

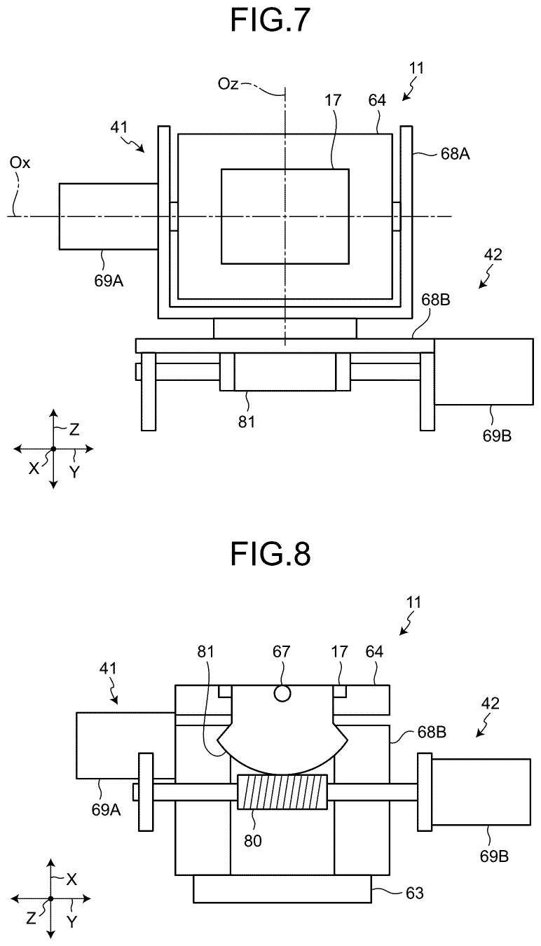

As illustrated in FIGS. 5 and 6, the display unit 11 emits a display image to be projected onto the windshield 103 toward the reflection mirror unit 12 as display light L. The display unit 11 emits the display light L that is narrower than the eye range ER, which is a light distribution range based on the distribution range of the eye points EP of the plurality of drivers D, and corresponds to the eye box EB, which is a light distribution range based on the eye point EP of the driver D acquired by the eye point acquisition unit 14. The display unit 11 has a light distribution range Pa in the up-down direction when viewed in the left-right direction (FIG. 5), and has a light distribution range Pb in the left-right direction when viewed in the up-down direction (FIG. 6). The light distribution range Pa is narrower than a light distribution range Pra corresponding to the eye range ER, and the light distribution range Pb is narrower than the light distribution range Prb corresponding to the eye range ER. The display unit 11 includes a light source 16, a display device 17, a housing 61, an optical lens 62, and a heat sink 63, which are illustrated in FIG. 5, and a first unit driver 41 and a second unit driver 42, which are illustrated in FIGS. 7 and 8.

The light source 16 is composed of, for example, one light emitting element mounted on a light source substrate 65. The light emitting element is, for example, a light emitting diode (LED). The light source substrate 65 is fixed to the housing 61, with the light source 16 being mounted on a so-called mounting surface. The light source 16 is turned on by electric power supplied from a battery (not illustrated) or the like mounted on the vehicle 100. Furthermore, the light source 16 is controlled to be turned on according to a control signal of the control unit 15.

The display device 17 is a so-called liquid crystal panel, and is formed of, for example, a light transmission type or light semi-transmission type thin film transistor (TFT) liquid crystal display. The display device 17 has a display area including a plurality of pixels. In the display area, the plurality of pixels are arranged in a matrix form. The display device 17 displays a display image including a number, a character, a figure, and the like as display information according to a control signal of the control unit 15. The display device 17 is disposed on an optical path of light emitted from the light source 16, and is illuminated from the light source 16, so that a display surface on a side opposite to the light source 16 in an optical axis direction emits light. The display device 17 is fixed to a device folder 64, and is connected to the housing 61 via the device folder 64.

The housing 61 accommodates, for example, the light source substrate 65 on which the light source 16 and the heat sink 63 are mounted, the optical lens 62, etc., and is rotatably supported in a predetermined direction by drive mechanisms 68A and 68B to be described below and the like. In the following description, it is assumed that the housing 61 includes a device folder 64 to which the display device 17 is fixed.

The optical lens 62 is disposed on the optical path between the light source 16 and the display device 17, and polarizes light incident from the light source 16 toward the display device 17. The optical lens 62 is formed of, for example, a high refractive index material such as a glass or a transparent resin, and refracts light that is going outward inward. The optical lens 62 is not limited to one lens, and may be constituted by a plurality of lenses.

The heat sink 63 is fixed to a surface of the light source substrate 65 opposite to the mounting surface, and is exposed to the outside of the housing 61. The heat sink 63 releases heat generated by the light source 16 and accumulated in the light source substrate 65 and the housing 61 to the outside of the display unit 11. The heat sink 63 is formed of, for example, a metal flat plate having high thermal conductivity, and includes a plurality of heat dissipation plates.

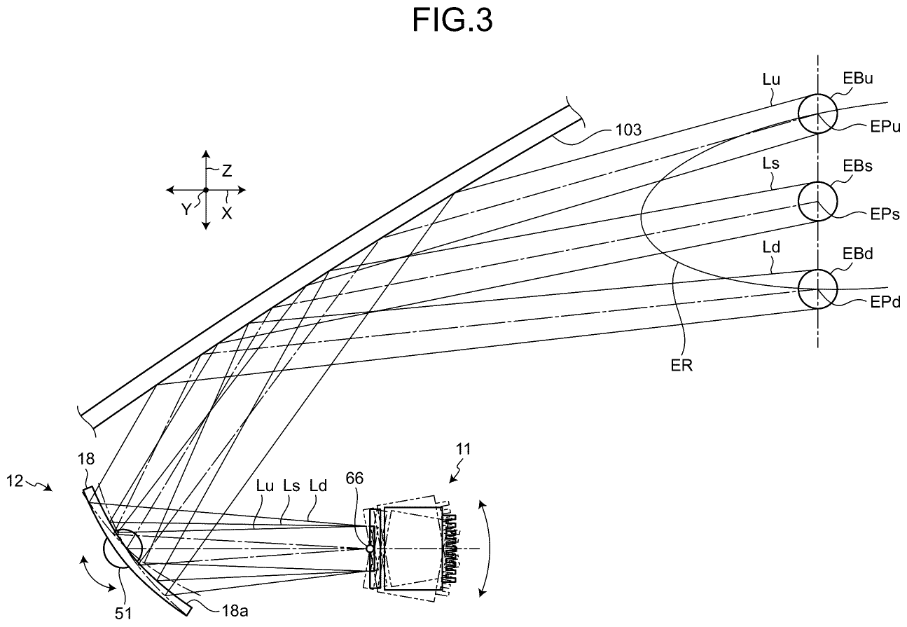

The first unit driver 41 is an example of a unit driver, and drives the display unit 11 in a first direction or in a second direction opposite to the first direction in such a manner that the direction in which the direction of the display light L is changed is an up-down direction of display information corresponding to the up-down direction of the eye point EP. As illustrated in FIGS. 3 and 5, the first unit driver 41 of the present embodiment causes the housing 61 to pivot about a pivot shaft 66 according to a movement of the eye point EP in the up-down direction. Here, the first direction and the second direction are one pivot direction and the other pivot direction of the housing 61 about the pivot shaft 66. For example, when the first unit driver 41 drives the display unit 11 in the first direction, the housing 61 pivots in one direction about the pivot shaft 66 to change the optical path of the display light L from the display unit 11 to the eye point EP. On the other hand, when the first unit driver 41 drives the display unit 11 in the second direction, the housing 61 pivots in the other direction about the pivot shaft 66 to change the optical path of the display light L from the display unit 11 to the eye point EP.

As illustrated in FIGS. 7 and 8, the first unit driver 41 includes a drive mechanism 68A and a motor 69A. The drive mechanism 68A causes the housing 61 to pivot about a pivot axis Ox, using the rotation of the motor 69A as power. The pivot axis Ox is along the pivot shaft 66. The motor 69A is, for example, a servo motor, a stepping motor, or the like. The motor 69A is connected to the control unit 15 via a communication line or the like, and is driven on the basis of a control signal from the control unit 15.

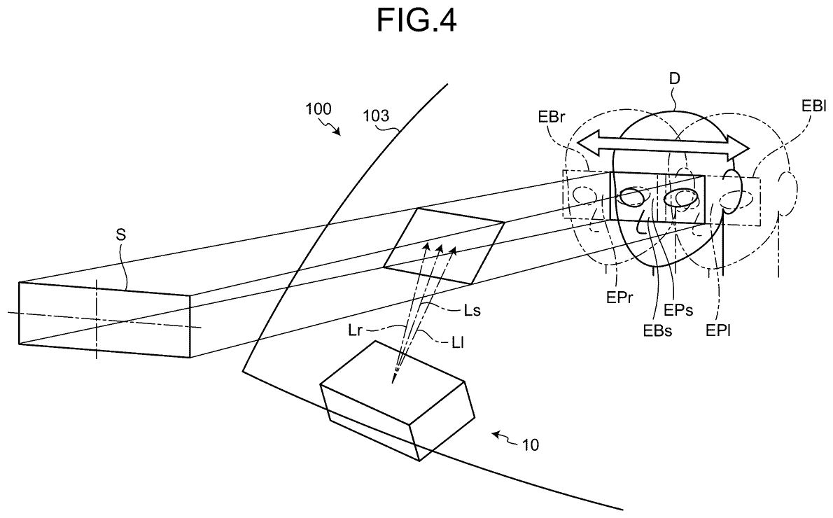

The second unit driver 42 is another example of a unit driver, and drives the display unit 11 in direction A or in direction B that is a direction opposite to the direction A in such a manner that the direction in which the direction of the display light L is changed is a left-right direction of display information corresponding to the left-right direction of the eye point EP. As illustrated in FIGS. 4 and 6, the second unit driver 42 of the present embodiment causes the housing 61 to pivot about a pivot shaft 67 according to a movement of the eye point EP in the left-right direction. Here, the direction A and the direction B are one pivot direction and the other pivot direction of the housing 61 about the pivot shaft 67. For example, when the first unit driver 41 drives the display unit 11 in the direction A, the housing 61 pivots in one direction about the pivot shaft 67 to change the optical path of the display light L from the display unit 11 to the eye point EP. On the other hand, when the first unit driver 41 drives the display unit 11 in the direction B, the housing 61 pivots in the other direction about the pivot shaft 67 to change the optical path of the display light L from the display unit 11 to the eye point EP.

As illustrated in FIGS. 7 and 8, the second unit driver 42 includes a drive mechanism 68B and a motor 69B. The drive mechanism 68B causes the housing 61 to pivot about a pivot axis Oz, using the rotation of the motor 69B as power. The pivot axis Oz is along the pivot shaft 67. The drive mechanism 68B is, for example, a worm gear including a worm 80 and a worm wheel 81. The motor 69B is, for example, a servo motor, a stepping motor, or the like. The motor 69B is connected to the control unit 15 via a communication line or the like, and is driven on the basis of a control signal from the control unit 15.

The reflection mirror unit 12 reflects the display light L incident from the display unit 11 toward the windshield 103. The reflection mirror unit 12 includes an aspheric mirror 18, a first reflector driver 51, and a second reflector driver 52.

The aspheric mirror 18 is an example of a reflector, and has a concave reflecting surface 18a. The shape of the reflecting surface 18a is a free-form curved surface. The reflecting surface 18a reflects a display image toward the windshield 103 while enlarging the display image.

The first reflector driver 51 is an example of a reflector driver, and drives the aspheric mirror 18 in a third direction or in a fourth direction opposite to the third direction in such a manner that the direction in which the direction of the display light L is changed is an up-down direction of display information corresponding to the up-down direction of the eye point EP. As illustrated in FIGS. 3 and 5, the first reflector driver 51 of the present embodiment causes the aspheric mirror 18 to pivot about a pivot shaft (not illustrated) in the left-right direction according to a movement of the eye point EP in the up-down direction. Here, the third direction and the fourth direction are one pivot direction and the other pivot direction of the aspheric mirror 18 about the pivot axis in the left-right direction. For example, when the first reflector driver 51 drives the reflection mirror unit 12 in the third direction, the aspheric mirror 18 pivots in one direction about the pivot shaft in the left-right direction to change the optical path of the display light L from the display unit 11 to the eye point EP. On the other hand, when the first reflector driver 51 drives the reflection mirror unit 12 in the fourth direction, the aspheric mirror 18 pivots in the other direction about the pivot shaft in the left-right direction to change the optical path of the display light L from the display unit 11 to the eye point EP.

The first reflector driver 51 has, for example, a structure in which a motor and a gear are combined, and changes the up-down direction of the aspheric mirror 18. The first reflector driver 51 has, for example, a structure in which the gear attached to a rotation shaft of the motor meshes with a plurality of teeth provided on the side opposite to the reflecting surface 18a of the aspheric mirror 18. The first reflector driver 51 is connected to the control unit 15 via a communication line or the like, and is driven on the basis of a control signal from the control unit 15. When the first reflector driver 51 receives the control signal from the control unit 15, the rotation shaft of the motor rotates, the power of the motor is transmitted to the aspheric mirror 18 by the meshing between the gear on the motor side and the plurality of teeth on the aspheric mirror 18 side, the aspheric mirror 18 rotates, and the up-down direction of the aspheric mirror 18 is changed.

The second reflector driver 52 is an example of a reflector driver, and drives the aspheric mirror 18 in direction C or in direction D opposite to the direction C in such a manner that the direction in which the direction of the display light L is changed is a left-right direction of display information corresponding to the left-right direction of the eye point EP. As illustrated in FIGS. 4 and 6, the second reflector driver 52 of the present embodiment causes the aspheric mirror 18 to pivot about a pivot shaft (not illustrated) in the up-down direction according to a movement of the eye point EP in the left-right direction. Here, the direction C and the direction D are one pivot direction and the other pivot direction of the aspheric mirror 18 about the pivot axis in the up-down direction. For example, when the second reflector driver 52 drives the reflection mirror unit 12 in the direction C, the aspheric mirror 18 pivots in one direction about the pivot shaft in the up-down direction to change the optical path of the display light L from the display unit 11 to the eye point EP. On the other hand, when the second reflector driver 52 drives the reflection mirror unit 12 in the direction D, the aspheric mirror 18 pivots in the other direction about the pivot shaft in the up-down direction to change the optical path of the display light L from the display unit 11 to the eye point EP.

The second reflector driver 52 has, for example, a structure in which a motor and a gear are combined, and changes the left-right direction of the aspheric mirror 18. The second reflector driver 52 has, for example, a structure in which the gear attached to a rotation shaft of the motor meshes with a plurality of teeth provided on the side opposite to the reflecting surface 18a of the aspheric mirror 18. The second reflector driver 52 is connected to the control unit 15 via a communication line or the like, and is driven on the basis of a control signal from the control unit 15. When the second reflector driver 52 receives the control signal from the control unit 15, the rotation shaft of the motor rotates, the power of the motor is transmitted to the aspheric mirror 18 by the meshing between the gear on the motor side and the plurality of teeth on the aspheric mirror 18 side, the aspheric mirror 18 rotates, and the left-right direction of the aspheric mirror 18 is changed.

The eye point acquisition unit 14 acquires an eye point EP of the driver D. The eye point acquisition unit 14 performs image processing on a driver image input by the vehicle interior photographing camera 20 to detect an eye point EP of the driver D. Specifically, for example, the eye point acquisition unit 14 detects a real eye point EP of the driver D on the basis of a position of an iris of an eyeball or a glabella of a face portion in the driver image. The eye point acquisition unit 14 outputs eye point information indicating the detected real eye point EP of the driver D to the control unit 15. The eye point information is represented by, for example, three-dimensional orthogonal coordinates.

The control unit 15 controls the display unit 11 to display display information. The control unit 15 includes, for example, an IC chip and the like mounted on a substrate, and is driven by power obtained from the battery mounted on the vehicle 100. The control unit 15 of the present embodiment drives and controls the first unit driver 41, the second unit driver 42, the first reflector driver 51, and the second reflector driver 52 on the basis of the eye point EP acquired by the eye point acquisition unit 14. Furthermore, the control unit 15 changes the optical path of the display light L from the display unit 11 to the eye point EP on the basis of the acquired eye point EP by driving and controlling the unit drivers (the first unit driver 41 and the second unit driver 42) and the reflector drivers (the first reflector driver 51 and the second reflector driver 52) in conjunction with each other.

Furthermore, in a case where a front image is input, the control unit 15 detects superimposition target information in actual scenery in front of the vehicle by a known image analysis method on the basis of the front image. The superimposition target information includes, for example, a surrounding vehicle (including an oncoming vehicle and a preceding vehicle), a pedestrian, a traffic light, a sign, a lane, and the like in the actual scenery in front of the vehicle. The control unit 15 controls the display unit 11 on the basis of the detected superimposition target information, and performs display image control of superimposing a virtual image S on a superimposition target in the actual scenery by displaying the superimposed virtual image to be superimposed on the superimposition target.

Next, an operation example of the vehicle display device 1 will be described with reference to FIGS. 3 to 6. The display light L emitted from the display device 17 of the display unit 11 is directed to the aspheric mirror 18. The aspheric mirror 18 reflects the display light L incident from the display unit 11 toward the windshield 103 by the concave reflecting surface 18a. As a result, a display image corresponding to the display light L is projected onto the windshield 103, and a virtual image S is displayed in front of the eye point EP of the driver D.

As illustrated in FIGS. 3 and 5, when the acquired eye point EP is positioned above a reference eye point EPs, the control unit 15 drives the housing 61 in the first direction (for example, the downward direction) by the first unit driver 41, and drives the aspheric mirror 18 in the third direction (for example, the upward direction) by the first reflector driver 51. When the acquired eye point EP is positioned below the reference eye point EPs, the control unit 15 drives the housing 61 in the second direction (for example, the downward direction) by the first unit driver 41, and drives the aspheric mirror 18 in the fourth direction (for example, the upward direction) by the first reflector driver 51. Specifically, the control unit 15 causes the housing 61 to pivot about the pivot shaft 66 in the first direction or the second direction, and causes the aspheric mirror 18 to pivot about the pivot shaft in the third direction or the fourth direction according to a position change between the reference eye point EPs and the real eye point EPu or EPd. Here, the reference eye point EPs is included in a reference eye box EBs, which is a light distribution range based on the reference eye point EPs. Further, the real eye point EPu is included in a real eye box EBu, which is a light distribution range based on the acquired real eye point EPu of the driver D, and the real eye point EPd is included in a real eye box EBd, which is a light distribution range based on the acquired real eye point EPd of the driver D.

The control unit 15 changes an optical path Ls of the display light L on the basis of the acquired real eye point EPu by driving and controlling the unit drivers (the first unit driver 41 and the second unit driver 42) and the reflector drivers (the first reflector driver 51 and the second reflector driver 52) in conjunction with each other. For example, when the acquired eye point EP is the real eye point EPu, the housing 61 is directed to the front lower side about the pivot shaft 66, and the reflecting surface 18a of the aspheric mirror 18 is directed to the rear lower side about the pivot axis. As a result, the optical path Ls of the display light L is changed to an optical path Lu. On the other hand, when the acquired eye point EP is the real eye point EPd, the housing 61 is directed to the front upper side about the pivot shaft 66, and the reflecting surface 18a of the aspheric mirror 18 is directed to the rear upper side about the pivot axis. As a result, the optical path Ls of the display light L is changed to an optical path Ld.

As illustrated in FIGS. 4 and 6, when the acquired eye point EP is on the right of the reference eye point EPs, the control unit 15 drives the housing 61 in the direction A (for example, the left direction) by the second unit driver 42, and drives the aspheric mirror 18 in the direction C (for example, the right direction) by the second reflector driver 52. When the acquired eye point EP is positioned on the left of the reference eye point EPs, the control unit 15 drives the housing 61 in the direction B (for example, the right direction) by the second unit driver 42, and drives the aspheric mirror 18 in the direction D (for example, the left direction) by the second reflector driver 52. Specifically, the control unit 15 causes the housing 61 to pivot about the pivot shaft 67 in the direction A or the direction B, and causes the aspheric mirror 18 to pivot about the pivot shaft in the direction C or the direction D according to a position change between the reference eye point EPs and the real eye point EPr or EPl. Here, the real eye point EPr is included in a real eye box EBr, which is a light distribution range based on the acquired real eye point EPr of the driver D, and the real eye point EPl is included in a real eye box EBl, which is a light distribution range based on the acquired real eye point EPl of the driver D.

The control unit 15 changes an optical path Ls of the display light L on the basis of the acquired real eye point EPr by driving and controlling the unit drivers (the first unit driver 41 and the second unit driver 42) and the reflector drivers (the first reflector driver 51 and the second reflector driver 52) in conjunction with each other. For example, when the acquired eye point EP is the real eye point EPr, the housing 61 is directed to the front left side about the pivot shaft 67, and the reflecting surface 18a of the aspheric mirror 18 is directed to the rear right side about the pivot axis. As a result, the optical path Ls of the display light L is changed to an optical path Lr. On the other hand, when the acquired eye point EP is the real eye point EPl, the housing 61 is directed to the front right side about the pivot shaft 67, and the reflecting surface 18a of the aspheric mirror 18 is directed to the rear left side about the pivot axis. As a result, the optical path Ls of the display light L is changed to an optical path Ll.

As described above, in the vehicle display device 1 according to the present embodiment, the display unit 11 emits display light corresponding to the eye box EB, which is narrower than the eye range ER, and is a light distribution range based on the eye point EP of the driver D. As a result, the display unit 11 emits the display light L that is narrower than the eye range ER, which is a light distribution range based on the distribution range of the plurality of eye points EP of the drivers D, and corresponds to the eye box EB, which is a light distribution range based on the eye point EP of the driver D acquired from the eye point acquisition unit 14. As a result, the amount of light from the light source 16 in the display unit 11 can be suppressed, thereby suppressing heat generation and achieving low power consumption. As a result, the heat sink 63 for cooling the light source 16 can be downsized, and the weight of the display unit 11 can be reduced. Furthermore, since the amount of light from the light source 16 can be suppressed, the cost can be reduced, for example, by reducing the number of LEDs. For example, by acquiring the eye point EP of the driver, the area ratio becomes about 50% or less with respect to the size of the normal eye box EB, so that the number of LEDs can be reduced (For example, when three LEDs are used, the number of LEDs can be reduced to one or two).

Furthermore, in the vehicle display device 1 according to the present embodiment, by driving and controlling the unit drivers and the reflector drivers in conjunction with each other, the control unit 15 changes the optical path of the display light L from the display unit 11 to the eye point EP on the basis of the acquired eye point EP. Specifically, when the acquired eye point EP is positioned above the reference eye point EPs, the control unit 15 drives the display unit 11 in the first direction by the first unit driver 41 and drives the aspheric mirror 18 in the third direction by the first reflector driver 51, and when the acquired eye point EP is positioned below the reference eye point EPs, the control unit 15 drives the display unit 11 in the second direction by the first unit driver 41 and drives the aspheric mirror 18 in the fourth direction by the first reflector driver 51. Furthermore, when the acquired eye point EP is positioned on the right of the reference eye point EPs, the control unit 15 drives the display unit 11 in the direction A by the second unit driver 42 and drives the aspheric mirror 18 in the direction C by the second reflector driver 52, and when the acquired eye point EP is positioned on the left of the reference eye point EPs, the control unit 15 drives the display unit 11 in the direction B by the second unit driver 42 and drives the aspheric mirror 18 in the direction D by the second reflector driver 52.

With the above-described configuration, the optical path of the display light L from the display unit 11 to the eye point EP is changed by driving and controlling the first and second unit drivers 41 and 42 and the first and second reflector drivers 51 and 52 in conjunction with each other on the basis of the eye point EP acquired from the driver D who gets on the vehicle 100. Thus, for example, when a driver D whose eye point EP is different in the up-down direction gets on the vehicle 100, it is possible to enable the driver D to visually recognize a virtual image S without deteriorating the visibility.

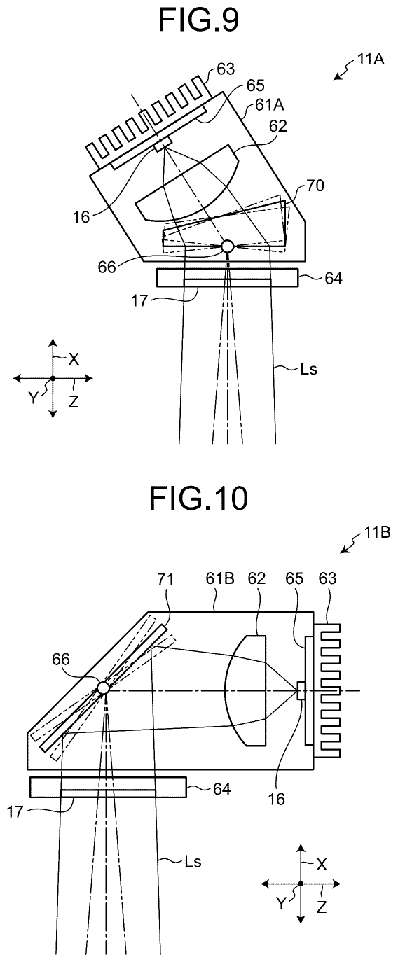

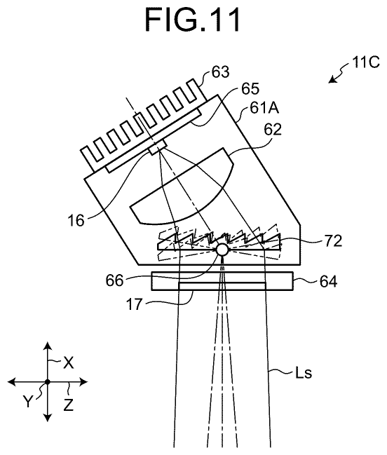

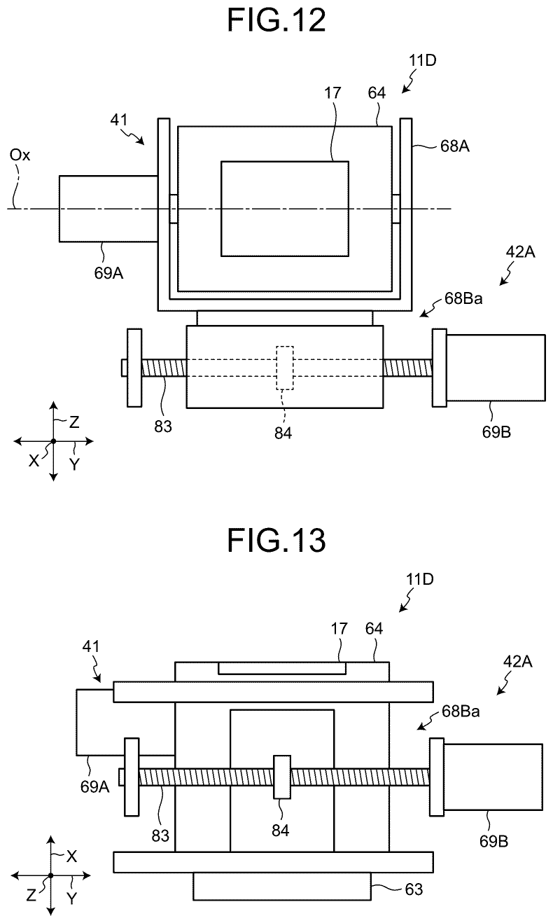

Next, a vehicle display device according to a modification of the embodiment will be described. FIG. 9 is a schematic diagram illustrating a schematic configuration of a display unit according to a first modification of the embodiment, and FIG. 10 is a schematic diagram illustrating a schematic configuration of a display unit according to a second modification of the embodiment. FIG. 11 is a schematic diagram illustrating a schematic configuration of a display unit according to a third modification of the embodiment. FIG. 12 is a schematic diagram of a schematic configuration of a display unit according to a fourth modification of the embodiment as viewed from the front, and FIG. 13 is a schematic diagram of a schematic configuration of the display unit according to the fourth modification of the embodiment as viewed from below.

A display unit 11A according to the first modification of the embodiment illustrated in FIG. 9 includes a housing 61A having a shape different from that of the housing 61, and a prism 70 disposed on an optical path between the optical lens 62 and the display device 17 to polarize light incident from the optical lens 62 toward the display device 17. The prism 70 is configured to be pivotable about the pivot shaft 66 by a driver (not illustrated). The display unit 11A drives the prism 70 in a first direction or in a second direction opposite to the first direction in such a manner that the direction in which the direction of the display light L is changed is an up-down direction of display information corresponding to the up-down direction of the eye point EP. The display unit 11A causes the prism 70 to pivot about the pivot shaft 66 according to a movement of the eye point EP in the up-down direction. Here, the first direction and the second direction are one pivot direction and the other pivot direction of the prism 70 about the pivot shaft 66. For example, when the display unit 11A drives the prism 70 in the first direction or the second direction, the prism 70 pivots in one direction or in the other direction about the pivot shaft 66 to change the optical path of the display light L from the display unit 11 to the eye point EP. As a result, effects similar to those of the above-described embodiment can be obtained.

A display unit 11B according to the second modification of the embodiment illustrated in FIG. 10 includes a housing 61B having a shape different from that of the housing 61, and a folding mirror 71 disposed on an optical path between the optical lens 62 and the display device 17 to reflect light incident from the optical lens 62 toward the display device 17. The folding mirror 71 is configured to be pivotable about the pivot shaft 66 by a driver (not illustrated). The display unit 11B drives the folding mirror 71 in a first direction or in a second direction opposite to the first direction in such a manner that the direction in which the direction of the display light L is changed is an up-down direction of display information corresponding to the up-down direction of the eye point EP. The display unit 11B causes the folding mirror 71 to pivot about the pivot shaft 66 according to a movement of the eye point EP in the up-down direction. Here, the first direction and the second direction are one pivot direction and the other pivot direction of the folding mirror 71 about the pivot shaft 66. For example, when the display unit 11B drives the folding mirror 71 in the first direction or the second direction, the folding mirror 71 pivots in one direction or in the other direction about the pivot shaft 66 to change the optical path of the display light L from the display unit 11 to the eye point EP. As a result, effects similar to those of the above-described embodiment can be obtained.

A display unit 11C according to the third modification of the embodiment illustrated in FIG. 11 includes a housing 61A and a Fresnel lens 72 disposed on an optical path between the optical lens 62 and the display device 17 to polarize light incident from the optical lens 62 toward the display device 17. The Fresnel lens 72 is configured to be pivotable about the pivot shaft 66 by a driver (not illustrated). The display unit 11C drives the Fresnel lens 72 in a first direction or in a second direction opposite to the first direction in such a manner that the direction in which the direction of the display light L is changed is an up-down direction of display information corresponding to the up-down direction of the eye point EP. The display unit 11C causes the Fresnel lens 72 to pivot about the pivot shaft 66 according to a movement of the eye point EP in the up-down direction. Here, the first direction and the second direction are one pivot direction and the other pivot direction of the Fresnel lens 72 about the pivot shaft 66. For example, when the display unit 11C drives the Fresnel lens 72 in the first direction or the second direction, the Fresnel lens 72 pivots in one direction or in the other direction about the pivot shaft 66 to change the optical path of the display light L from the display unit 11 to the eye point EP. As a result, effects similar to those of the above-described embodiment can be obtained.

A display unit 11D according to the fourth modification of the embodiment illustrated in FIGS. 12 and 13 includes a second unit driver 42A having a configuration different from that of the second unit driver 42. The second unit driver 42A includes a drive mechanism 68Ba and a motor 69B. The drive mechanism 68Ba rotates a screw shaft 83, by using the rotation of the motor 69B as power. The screw shaft 83 extends along the left-right direction. The drive mechanism 68Ba is, for example, a ball screw including a screw shaft 83 and a nut 84. When the screw shaft 83 rotates to one side according to the rotation of the motor 69B, the housing 61 moves to one side in the left-right direction, and when the screw shaft 83 rotates to the other side, the housing 61 moves to the other side in the left-right direction. As a result, the direction of the display light L emitted from the display unit 11D in the left-right direction can be changed.

In the vehicle display device 1 according to the embodiment described above, the control unit 15 drives and controls the first and second unit drivers 41 and 42 and the first and second reflector drivers 51 and 52 in conjunction with each other, but the present invention is not limited thereto. For example, in the vehicle display device 1 according to another modification of the embodiment, the control unit 15 may drive and control the first unit driver 41 and the first reflector driver 51 in conjunction with each other. In this case, when the acquired eye point EP is positioned above the reference eye point EPs, the control unit 15 drives the display unit 11 in the first direction by the first unit driver 41, and drives the aspheric mirror 18 in the third direction by the first reflector driver 51. On the other hand, when the acquired eye point EP is positioned below the reference eye point EPs, the control unit 15 drives the display unit 11 in the second direction by the first unit driver 41, and drives the aspheric mirror 18 in the fourth direction by the first reflector driver 51.

With the above-described configuration, when a driver D whose eye point EP is different in the up-down direction gets on the vehicle 100, it is possible to enable the driver D to visually recognize a virtual image S without deteriorating the visibility even if the eye point EP of the driver D is not within the range of the eye range ER in the up-down direction.

In addition, in the vehicle display device 1 according to the embodiment described above, the control unit 15 drives and controls the first and second unit drivers 41 and 42 and the first and second reflector drivers 51 and 52 in conjunction with each other, but the present invention is not limited thereto. For example, in the vehicle display device 1 according to another modification of the embodiment, the control unit 15 may drive and control the first and second unit drivers 41 and 42 and the first reflector driver 51 in conjunction with each other, or may drive and control only the second unit driver 42. In the former case, when the acquired eye point EP is positioned above the reference eye point EPs, the control unit 15 drives the display unit 11 in the first direction by the first unit driver 41, and drives the aspheric mirror 18 in the third direction by the first reflector driver 51. In addition, when the acquired eye point EP is positioned below the reference eye point EPs, the control unit 15 drives the display unit 11 in the second direction by the first unit driver 41, and drives the aspheric mirror 18 in the fourth direction by the first reflector driver 51. In addition, when the acquired eye point EP is positioned on the right of the reference eye point EPs, the control unit 15 drives the display unit 11 in the direction A by the second unit driver 42, and when the acquired eye point EP is positioned on the left of the reference eye point EPs, the control unit 15 drives the display unit 11 in the direction B by the second unit driver 42. In the latter case, when the acquired eye point EP is positioned on the right of the reference eye point EPs, the control unit 15 drives the display unit 11 in the direction A by the second unit driver 42, without driving the first and second reflector drivers 51 and 52. When the acquired eye point EP is positioned on the left of the reference eye point EPs, the display unit 11 is driven in the direction B by the second unit driver 42.

In the above-described embodiment, the shape of the reflecting surface 18a of the aspheric mirror 18 is a free-form curved surface, but the present invention is not limited thereto.

Further, in the above-described embodiment, the vehicle display device 1 projects a display image onto the windshield 103 of the vehicle 100, but the present invention is not limited thereto, and for example, the display image may be projected onto a combiner or the like.

Further, in the above-described embodiment, the vehicle display device 1 is applied to the vehicle 100 such as an automobile, but the present invention is not limited thereto, and the vehicle display device 1 may be applied to, for example, a ship or an aircraft or the like other than the vehicle 100.

According to the vehicle display device of the present invention, it is possible to achieve the low power consumption of the display unit.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A vehicle display device comprising:
a display unit that emits display information as display light, the display information being projected onto a projected member of a vehicle and visually recognized by a driver inside the vehicle as a virtual image;
a reflector that reflects the display light incident from the display unit toward the projected member;
an eye point acquisition unit that acquires an eye point of the driver,
a unit driver that drives the display unit to change a direction of the display light from the display unit toward the reflector;
a reflector driver that drives the reflector to change a direction of the display light from the reflector toward the projected member; and
a control unit that drives and controls the unit driver and the reflector driver on the basis of the acquired eye point,
wherein the display unit emits the display light that is narrower than an eye range, which is a light distribution range based on a distribution range of eye points of a plurality of drivers, and corresponds to an eye box, which is a light distribution range based on the eye point of the driver acquired by the eye point acquisition unit, and
the control unit changes an optical path of the display light from the display unit to the eye point on the basis of the acquired eye point by driving and controlling the unit driver and the reflector driver in conjunction with each other.

2. The vehicle display device according to claim 1,
wherein the unit driver drives the display unit in a first direction or in a second direction opposite to the first direction in such a manner that a direction in which the direction of the display light is changed is an up-down direction of the display information corresponding to an up-down direction of the eye point,
the reflector driver drives the reflector in a third direction or in a fourth direction opposite to the third direction in such a manner that the direction in which the direction of the display light is changed is the up-down direction of the display information corresponding to the up-down direction of the eye point,
when the acquired eye point is positioned above a reference eye point, the control unit drives the display unit in the first direction by the unit driver, and drives the reflector in the third direction by the reflector driver, and
when the acquired eye point is positioned below the reference eye point, the control unit drives the display unit in the second direction by the unit driver, and drives the reflector in the fourth direction by the reflector driver.

3. The vehicle display device according to claim 1,
wherein the unit driver drives the display unit in direction A or in direction B opposite to the direction A in such a manner that a direction in which the direction of the display light is changed is a left-right direction of the display information corresponding to a left-right direction of the eye point,
when the acquired eye point is positioned on a right side of a reference eye point, the control unit drives the display unit in the direction A by the unit driver, and
when the acquired eye point is positioned on a left side of the reference eye point, the control unit drives the display unit in the direction B by the unit driver.

4. The vehicle display device according to claim 1,
wherein the unit driver includes:
a first unit driver that drives the display unit in a first direction or in a second direction opposite to the first direction in such a manner that a direction in which the direction of the display light is changed is an up-down direction of the display information corresponding to an up-down direction of the eye point; and
a second unit driver that drives the display unit in direction A or in direction B opposite to the direction A in such a manner that the direction in which the direction of the display light is changed is a left-right direction of the display information corresponding to a left-right direction of the eye point;
the reflector driver includes a first reflector driver that drives the reflector in a third direction or in a fourth direction opposite to the third direction in such a manner that the direction in which the direction of the display light is changed is the up-down direction of the display information corresponding to the up-down direction of the eye point,
when the acquired eye point is positioned above a reference eye point, the control unit drives the display unit in the first direction by the first unit driver, and drives the reflector in the third direction by the first reflector driver,
when the acquired eye point is positioned below the reference eye point, the control unit drives the display unit in the second direction by the first unit driver, and drives the reflector in the fourth direction by the first reflector driver,
when the acquired eye point is positioned on a right side of the reference eye point, the control unit drives the display unit in the direction A by the second unit driver, and
when the acquired eye point is positioned on a left side of the reference eye point, the control unit drives the display unit in the direction B by the second unit driver.
